(19) United States
(12) Patent Application Publication
(10) Pub. No.: US 2010/0248950 A1
(43) Pub. Date: Sep. 30, 2010

(54) METHOD FOR MAKING SILICA SUPPORTED CATALYSTS

(76) Inventor: Heiko Morell, Rodgau (DE)

Correspondence Address: GRACE GMBH & CO. KG, 7500 GRACE DRIVE, COLUMBIA, MD, 21044, US

(21) Appl. No.: 12/666,030

(22) PCT Filed: Jul. 4, 2008
(86) PCT No.: PCT/EP2008/005509

§ 371 Date: Jun. 7, 2010

Related U.S. Application Data
(60) Provisional application No. 60/958,341, filed on Jul. 5, 2007.

(51) Int. Cl. B01J 21/08; B01J 23/02; B01J 23/04

(52) U.S. Cl. 502/239; 502/300; 502/344; 502/340; 502/237

(57) ABSTRACT

A method for making an inorganic oxide supported catalyst involves impregnating an inorganic oxide component with a catalytic metal using an aqueous, acid bath. More specifically, the method involves forming and washing an inorganic oxide component, such as a silica gel or a silica co-gel, for example a silica-zirconia co-gel. The washed inorganic oxide component is then contacted with the acidic bath to effect the impregnation with the catalytic metal, such as cesium, to form an activated inorganic oxide component. Subsequently, the activated component is dried to form the catalyst. The resulting catalysts possess increased surface area, which is beneficial with respect to accessibility and amount of catalytically active sites.

### FIELD OF THE INVENTION

The present invention pertains to making inorganic oxide supported catalysts, and in particular, catalysts utilizing porous materials to support catalytic metal species.

### BACKGROUND OF THE INVENTION

Inorganic oxides, e.g., porous silica gels and other silica-based components, are widely used as catalyst supports in industry. For fixed bed or fluidized bed type processes, catalysts in a formed shape, such as extrudates, are usually required. Two approaches have been commonly used to produce formed catalyst particles. One involves the impregnation of catalyst components on preformed support particles, and the other involves the preparation of inorganic oxide supported catalyst powders and then processing the powders into formed catalyst particles.

In many catalytic applications, reaction steps are controlled by accessibility and amount of catalytic active sites on the catalyst particle. In porous materials, larger surface areas (SA) are therefore typically preferred for the catalytic processes. Larger surface areas not only provide accessibility to increased catalytic active sites, but more importantly they also have a direct influence on reactions constants. Larger surface areas normally allow quicker reactions, which is then related to improved economics for material produced per time.

Processed powder particle catalysts, e.g., such as extrudates, often have decreased surface areas, because the pore structure tends to collapse during the mechanical extrusion process. They also typically have higher manufacturing costs. As a result, impregnating granular particles is often a preferred method. Granules, however, often have mechanical stability limitations. Beads offer another embodiment of particulate supports. Such supports are often prepared by forcing bead precursors through nozzles to form beads that are later cured into finished beads. These beads are similar to granulated particles, but mechanically more stable. Therefore, it would be desirable to find a solution that combines the advantages of spherical form (bead) with increased surface area typically found on the impregnated particles.

### SUMMARY OF THE INVENTION

The method of this invention comprises forming an inorganic oxide component and then washing it. The method further comprises contacting the component with an aqueous acidic bath comprising a catalytic metal to impregnate the component with the metal. It has been found that impregnating the support in an acid bath enhances pore size distribution, thereby reducing diffusion limitation vis à vis a reactant's access to catalytically active sites on the support. The activated component is dried, thereby rendering the final dried product suitable for use in a number of catalytic processes for manufacturing chemical compounds.

It is to be understood that both the foregoing general description and the following detailed description are exemplary, but not restrictive, of the invention.

### DETAILED DESCRIPTION

The present invention is directed to a method of making a catalyst, particularly an inorganic oxide supported catalyst. Such catalysts are useful for catalyzing the aldol condensation of propionic acid or propionic ester to methacrylic acid. Other uses of catalysts prepared by the present invention include olefin polymerization, dehydration, hydroxylation, and isomerization. The catalysts of the present invention can be used as catalysts in a fixed bed reactor or in other reaction environments, e.g., fluidized bed reactors.

In general, four steps are involved in preparing the catalysts of the present invention and are carried out in the following order:
1. forming an inorganic oxide component;
2. washing the component;
3. contacting the component with an aqueous, acidic bath comprising a catalytic metal to impregnate the component with the catalytic metal to form an activated component; and
4. drying the activated inorganic oxide component.

The first step above, forming an inorganic oxide component, can be one of a number of conventional processes for forming inorganic oxides. Suitable inorganic oxides are those typically employed as catalyst supports, especially porous supports to which catalytic species are to be impregnated and retained on the support's surface. According, relatively porous inorganic oxides are preferred. Such porous supports provide exceptional surface area onto which catalytically active species can be applied, not only to the peripheral surfaces of the particles, but also to the surfaces of the internal porous structure within the particle itself. This internal surface area is accessible through pores entering the porous structure of the particles.

A silica is a preferred inorganic oxide for use in the present invention. A suitable silica component can be any compound having silica (SiO₂) and used as a support for catalysts, such as silica gels, co-gels, and precipitated silica, among others. Such silica components can be made by conventional processes of preparation and purification. For example, a silica component can be formed by the methods described in U.S. Pat. Nos. 4,422,959 to Lawson et al., 3,972,833 to Michalko et al., or 5,625,013 to Mueller et al. or Canadian Patent No. 1,064,008 to van Beem et al., each of which is incorporated by reference herein.

More specifically, a silica gel may be formed by simultaneously and instantaneously mixing aqueous solutions of a mineral acid, such as sulfuric acid, and an alkali metal silicate, such as sodium or potassium silicate. The concentrations and flow rates or proportions may be adjusted so that the hydrosol contains about 5 to 25% SiO₂ and the majority of the alkali metal present in the silicate solution is neutralized. The silicate/acid mixture is then forced through a conventional nozzle employing standard techniques. From the nozzle, the mixture forms hydrosol beads, which are allowed to set quickly to form a hydrogel. The beads may be caught in water, which preferably has a pH less than 7.0, and more preferably less than 4.0.

In one embodiment in which cesium is used as the catalytic metal and the catalyst is used in the production of ethylenically unsaturated acids or esters, in the form of beads, the hydrosol contains about 15 to about 20% silica (SiO₂), has a pH of about 7 to 8, and gels in a matter of 20 to 1,000 milliseconds. This results in a silicate solution which is only partially neutralized by the mineral acid, in which case the reactants are formed into spheres by spraying in air. As is well known, a partially neutralized hydrogel (i.e., on the alkaline side), has a relatively short gel time and will form a sphere in air.

As mentioned above with respect to silica embodiments, the inorganic oxide component may be a co-gel. In this event, the step of forming the co-gel involves combining an alkali metal oxide, e.g., silicate when the inorganic oxide is silica, a mineral acid, and a source of a second metal to form a hydrosol and allowing the hydrosol to set. In one co-gel embodiment, the mineral acid may be first mixed with the source of the second metal to form a mixture, which is then combined with the alkali metal oxide. Alternatively, the second metal source may be intermixed with the mineral acid and alkali metal oxide solution via a separate stream.

The second metal may, under some conditions, serve to stabilize the catalyst in operation and also might serve to improve the catalytic activity. Such metals include zirconium, titanium, aluminum, iron, etc. The selection of these and other metals is well known to those skilled in the art and depends on the desired end use of the catalyst, among other factors. For example, titanium is a suitable component in an oxidation catalyst and aluminum is known to be a suitable component in an alkylation catalyst. The particular amount of second metal can be identified by one skilled in the art, recognizing that too little amount of the second metal will not have any stabilizing influence, while too much second metal could adversely affect the catalyst's selectivity. A typical range of the second metal might be such that it comprises about 0.05 to 1.5 weight percent of the final catalyst (dry basis), although this range will vary based on a number of factors.

In one embodiment, such as is disclosed in WO 99/52628, incorporated herein by reference, the stabilizing metal is zirconium and the source of zirconium is zirconium ortho-sulfate. Other sources of zirconium include zirconium nitrate, zirconium sulfate, zirconyl chloride, and zirconyl bromide, among others. Methods for preparing silica-zirconia co-gels are well-known in the art and some such methods are described in U.S. Pat. No. 5,069,816, incorporated herein by reference.

As mentioned above, the inorganic oxide component of this invention is preferably silica, which may be in the form of silica gel beads (or silica gel beads doped with other metals) and may be formed by partially neutralizing sodium silicate with sulfuric acid (or acid doped with other metals, usually in the form of metal sulfates or ortho-sulfates). More specifically, silica hydrosols are formed by simultaneously and instantaneously mixing sodium silicate and acid, and are then forced through a nozzle. From the nozzle, the mixture forms hydrosol droplets, which are allowed to set quickly to form hydrogel beads. The size of the beads is not critical and can vary over a wide range. In some applications, the bead size may vary from less that 0.5 millimeter (mm) to 8 mm, more typically between 1 mm and 4 mm, the size range for most fixed bed operations.

The inorganic oxide component is then washed. When the component is silica-based, one washing method comprises acidifying the silica-based component, and then washing it with acidified or deionized water to reduce the concentrations of metal impurities such as sodium, potassium, iron, aluminum, titanium, magnesium, and calcium. For example, silica beads may be acidified by exposure to sulfuric acid, such as to a pH less than 4.0, preferably between about 2.0 to 3.0, and more preferably to about 2.5. The acidified water used may have a pH adjusted to between about 2.0 to 4, and more preferably between about 2.0-3.0, typically by use of sulfuric acid. The temperature of the wash bath can be in the range of 20-90° C. It is noted that when washing the inorganic oxide components, the components can also be undergoing a process that those skilled in the art also refer to as “aging” or some grammatical variation thereof. Without being held to a particular theory, it is believed that processes that perform the aforementioned washing function also have an aging function that imparts certain properties to the intermediate and final products being prepared. For example, it is believed that the inorganic oxide in the component is redistributed, preferably in a beneficial way, during the washing process. Potential beneficial properties include enhancing the attrition of the final product and/or modifying porosity and pore size distribution. Therefore, reference to “washing” processes and steps herein embraces processes that both remove the aforementioned contaminants from the inorganic oxide component, i.e., wash, and age the components.

No one washing method is particularly preferred and other known methods may be employed. Regardless of the particular washing method used, multiple washing stages may be employed as is well known in the art, until the sodium concentration in the effluent is at or below an acceptable level, preferably at or close to zero. This can be determined by atomic absorption or, more easily, by ion conductivity. The washing may occur as a batch process, by concurrent flow, or by countercurrent flow.

The washed inorganic oxide component is then contacted with an aqueous, acid bath containing a catalytic metal. The conditions of this step, such as the contact time and temperature, are chosen to allow for impregnation of the component with the catalytic metal to form an activated component. Preferably, the conditions are selected so that the reaction between metal and surface hydroxyl groups reaches or nearly reaches equilibrium. In most cases, a certain metal loading is targeted, for example, targeting 6 wt. % cesium (dry basis) on a gel with a surface area of 350 m²/g. The specific conditions will vary depending on a number of factors, such as the type of the inorganic oxide component, the hydroxyl concentration of the component, and the specific catalytic metal used and its form. Therefore, contact times and temperatures can vary over a wide range, such as between about 1 to 8 hours and from room temperature to up to 60° C. or higher. A contact time of 2.0 hours is often sufficient. The concentration of the aqueous, acidic bath may also vary over a wide range, keeping in mind the solubility limit of the catalytic metal. For example, the concentration of metal may range from about 2 to about 8% by weight of the bath, depending on the bath's pH. Lower pHs require higher metal concentrations to lay down effective catalyst loading. For example, if the impregnation bath is about pH of 2, the metal concentration in the bath will more than likely need to be about 8% by weight. Slight agitation can be used to encourage impregnation, but it should not too strong so as to cause some of the spheres to break.

It has been found that when impregnating the component with the catalytic metal under acidic conditions, advantageous accessible surface area for reactants are achieved. Without being held to a particular theory, it is believed that the acidity of the impregnation bath leads to enhanced surface area. It is also noted that the acid impregnation bath leads to preservation of pores' sizes present or created during the preparation and washing of the inorganic oxide component. The pH of the bath is acidic as measured at the end of the impregnation, i.e., having a pH of less than 7.0, including a pH of 0 and/or negative pHs. Preferably, the pH of the acidic bath should be between about 1.0 and 6.5, and even more preferably between about 3.0 and 5.0. The pKa of preferred acids used to produce the acidic bath are in the range of about 1 to 5. Acids having pKa's in the range of about 3 to about 5 are especially preferred, although strong acids can also suitable if appropriately diluted. Formic acid or acetic acid are particularly suitable for manufacturing the catalyst impregnation bath of this invention. The amount of acid may vary over a wide range. When the inorganic oxide component is a silica hydrogel, the amount of acid can be between 0.07 to 0.12 grams acid per gram silica hydrogel at pH of 2 to 3. On the other hand, when the bath pH is around 6.5, the amount of acid could be small, e.g., 0.0004/g.

The acidic bath may include a salt of the catalytic metal, and the catalytic metal may be one or more of the alkali and/or alkaline earth metals, as well as other metals. In cases where cesium is used as the catalytic metal, it is mixed with water in the form of cesium formate, cesium carbonate, cesium nitrate, cesium acetate, cesium chloride, etc. The acidic bath is preferably buffered to prevent drastic drops in pH changes that would adversely affect the inorganic oxide and/or deposition of the catalytic metal onto the support. After the impregnation step, the inorganic oxide component is deemed “activated” in that an active catalytic component is impregnated thereon.

Generally, embodiments of the process that employ cesium as the catalytic metal can result in final catalysts comprising about 2 to about 16% by weight cesium, with cesium amounts in the range of about 4 to about 12% by weight on a dried basis being more typical.

The activated inorganic oxide component is dried, such as in a drying unit or oven. When the component is silica, the component can be dried to anywhere from between about 0.01% to 25% by weight moisture content. Typically, the catalyst is dried to less than 5% by weight moisture. Either in the same unit or in a separate unit, the dried component may then be calcined. Whether to calcine or not depends largely on the inorganic oxide, and the end use of the catalyst. The details of calcination are well known to those skilled in the art. The calcination conditions can be determined empirically and depend on a number of factors, including the composition of the inorganic oxide, the intended use of the catalyst, etc.

The catalysts of this invention may be used in fixed bed and fluidized bed applications, in which case the catalysts may be used in their spherical form as made. The catalysts may also be ground and used as powders or reformed into granules, pellets, aggregates, or extrudates. The form of the catalysts is primarily dictated by the desired end use of the catalysts and the conditions during that end use. Particle sizes for fixed bed catalyst particles range from 1 mm to about 8 mm or larger. Particle sizes for fluidized bed applications are generally less than 1.0 mm.

The porosimetric properties of the catalyst of this invention are particularly advantageous. These properties include increased pore volume, pore diameter, and surface area of the component compared to the same catalyst prepared using an alkaline impregnation bath. See, for example, U.S. 2003/0069130. Specific values, however, are to some extent dictated by the end use of the catalysts. It is believed that, in many cases, the higher the surface area of the catalyst, the more active the catalyst. Moreover, as noted above, the invention maintains relatively large average pore sizes, and therefore, catalysts prepared from this invention can be active for a wider range of reactants. Thus, a pore volume of at least 0.80 ml/g, surface area of at least 300 m²/g and an average pore diameter (APD) of at least 8.0 nm are desirable in many cases, with pore volume, surface area and pore volume measured by BET¹ methods; and APD being calculated from BET measurements.² The invention generally results in catalysts having pore volumes ranging from 0.50 ml/g to about 1.1 ml/g, surface areas of 250 m²/g to about 550 m²/g, with 350 m²/g to about 450 m²/g more typical. As indicated above, it is desirable that the average pore diameter of the inorganic oxide component be above a certain threshold value so that the reactants in the desired end use can reach the internal surfaces of the catalyst. The APD is generally affected by the catalytic metal loading in the final catalysts. As the loading of catalytic metal in the catalyst increases, the APD is likely to be towards the lower end of the range, e.g., the APD falls in the range of 5 to 8 mm, while as the loading of catalytic metal decreases, the APD tends to be in the upper end of the range of APD, e.g., in the range of 11 to 15 nm. ¹Surface area and pore sizes reported herein are measured using BET techniques. The ranges above and the results in the following examples are measured using the following conditions on a ASAP porosimeter.

Measurement Type: 13 points (Point 1 top 5 for surface area, 6-13 for pore volume).
Fast evacuation: no
Leak test interval: 120 sec
Equilibrium interval: 20 sec
P/P0 tolerance: 2.0% 1.0 mmHg
P0 interval: 60 min
Fixed dose: 0.0 cc/g STP applied up to 0.0000 p/p0 ²Average Pore Diameter (APD) calculated by the following formula: (BET PV×40,000)/BET SA

The scope of the invention is not in any way intended to be limited by the examples set forth below. The examples are given as specific illustrations of the claimed invention. It should be understood, however, that the invention is not limited to the specific details set forth in the examples.

All parts and percentages in the examples, as well as the remainder of the specification which refers to solid compositions or concentrations, are by weight unless otherwise specified. Concentrations of gaseous mixtures are by volume unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited.

### EXAMPLES

### Example 1

### Step 1: Bead Run Off

A mixture of sulphuric acid (24500 g) (15 wt. % concentration) mixed with zirconium ortho-sulphate (850 g) (18 wt. % concentration) and sodium silicate (12567.58 g) (17.5 wt. % SiO₂ concentration) is run off in a mixing nozzle with a ratio (sulphuric acid+zirconium ortho-sulphate) to sodium silicate of 1.16. The gelation time is less than one second and the beads are formed in the air during the flight of the mixture from the nozzle to a collecting pool. The water in the collecting pool is adjusted to pH of 3.0. Silica/zirconia (Si—Zr) hydrogel beads are collected.

### Step 2: Washing of the Beads

The recovered beads are washed in various steps in order to reduce the concentration of metal impurities. The beads are then run through a washing process that changes the pore structure and mechanical strength of the material. The washing process steps comprise

a) washing with sulphuric acid solution at pH 2.0-2.5 at 20° C. for 18 hours;

b) letting the component sit in an ammonia solution at pH 9.0-10.0 at 75° C. for 4 hours;

c) washing in sulphuric acid solution at pH 3.0-5.0 at 35-40° C. for 20 minutes, the step repeated 5 times; and

d) washing with deionized-water at 35° C. for 15 minutes, the step repeated 2 times.

### Step 3: Impregnation of the Hydrogel Bead with Cesium

The Si—Zr hydrogel beads are impregnated with 6 wt % cesium formate solution at pH 2.5 (buffered with Formic Acid) at room temperature for 2.5 hours.

### Step 4: Drying of the Hydrogel Beads

The wet hydrogel beads were dried at 90° C. for 18 h in an oven. The resulting dried, activated catalyst had the following properties.

Results:

Surface Area (BET)=361 m2/g

Pore Volume (BET)=0.90 ml/g

Average Pore Diameter (calculated)=10.0 nm

Total Volatile content @950° C.=8.4%

Cesium (Cs) content 13.1 wt % db

Zirconium (Zr) content=1.04 wt % db

### Example 2

Six additional catalysts were prepared as follows. The results show increasing average pore volume and average pore diameter, as the pH of the impregnation bath is lowered.

Step 1: Bead Run Off

A mixture of 25 kg sulphuric acid (15 wt % concentration) mixed with 1 kg zirconium-ortho-sulphate (18 wt % concentration) and 13 kg sodium-silicate (17.5 wt % SiO₂ concentration) was run off in a mixing nozzle with a ratio (sulphuric acid+zirconium-ortho-sulphate) to sodium silicate of 1.27. The gelation time was less than one second and the beads were formed in the air during the flight of the mixture from the nozzle to a collecting pool. The water in the collecting pool was adjusted to pH of 4.0. Prior to gelation the sodium silicate was cooled to 7° C. and the sulphuric acid+zirconium-ortho-sulphate mixture to 4.5° C.

Step 2: Washing of the Beads

The beads were washed in 12 steps in order to reduce the concentration of metal impurities. The steps were as follows:

a) washing with sulphuric acid solution at pH 3.0 at 40° C. for 18 hours;

b) additional washing with ammonia solution at pH 9.0 at 80° C. for 3 hours;

c) washing again with sulphuric acid solution at pH 2.5 at 40° C. for 20 minutes, which was repeated 5 times; and

d) washing with deionized water at 40° C. for 15 minutes, which was repeated 5 times.

Step 3: Impregnation of the Hydrogel Bead with Cesium

The Si—Zr hydrogel beads were impregnated with cesium formate solution at three pH levels and three different cesium concentrations at room temperature for 2.5 hours. The pH and concentrations for each are indicated in Table 1 below.

TABLE 1

| | | Cs-concentration of the |
|---|---|---|
| Sample Name | pH | impregnation solution [wt %] |
| A1 | 6.0 | 3.6 |
| A2 | 6.0 | 4.6 |
| B1 | 4.0 | 3.6 |
| B2 | 4.0 | 4.6 |
| C1 | 2.5 | 3.6 |
| C2 | 2.5 | 4.6 |

Step 4: Drying of the Hydrogel Beads

The wet hydrogel beads were dried at 80° C. for 18 hours in an oven resulting in a total volatile of average 5.5% when measured at 950° C.

Pore structure results are shown in Table 2 below.

Reducing the pH at a given Cs loading increases pore volume and average pore diameter. Particularly advantageous results were found at pH 4.0.

TABLE 2

| | Cs loading on | | | |
|---|---|---|---|---|
| | the sample | Surface | | Average Pore |
| Sample | [wt. %] dry | Area (BET) | Pore Volume | Diameter [nm] - |
| Name | basis | [m²/g] | (BET) [ml/g] | calculated |
| A1 | 5.1 | 380 | 0.84 | 8.8 |
| A2 | 6.7 | 351 | 0.81 | 9.2 |
| B1 | 5.1 | 402 | 0.88 | 9.0 |
| B2 | 6.7 | 369 | 0.83 | 9.2 |
| C1 | 5.1 | 387 | 0.96 | 10.1 |
| C2 | 6.7 | 340 | 0.88 | 10.4 |

1. A method for making a catalyst comprising forming an inorganic oxide component; washing said component; contacting said component with an aqueous, acidic bath comprising a catalytic metal to impregnate said component with said catalytic metal to form an activated component; and drying said inorganic oxide component to form said catalyst.

2. The method in accordance with claim 1, wherein said acidic bath has a pH of between about 1.0 and about 6.5 at the end of the metal impregnation.

3. The method in accordance with claim 2, wherein said acidic bath has a pH of between about 3.0 and about 5.0 at the end of the metal impregnation.

4. The method in accordance with any preceding claim, wherein the aqueous acidic bath is prepared using an acid having a pKa in the range of about 1 to 5.

5. The method in accordance with claim 4, wherein the aqueous acidic bath is prepared using an acid having a pKa in the range of about 3 to 5.

6. The method in accordance with any preceding claim, wherein said acidic bath further comprises a salt of said catalytic metal, wherein said catalytic metal is selected from the group consisting of alkali metal and alkaline earth metal.

7. The method in accordance with claim 6, wherein said salt is a salt of said catalytic metal and formic acid.

8. The method in accordance with claim 6, wherein said catalytic metal is cesium and said salt is selected from the group consisting of cesium carbonate, cesium formate, cesium acetate, cesium nitrate, cesium chloride, and mixtures thereof.

9. The method in accordance with any preceding claim, wherein said inorganic oxide component comprises silica.

10. The method in accordance with claim 9, wherein said silica comprises silica gel and the step of forming said silica gel comprises mixing an alkali metal silicate with a mineral acid to form a hydrosol and allowing said hydrosol to set.

11. The method in accordance with claim 9, wherein said silica comprises a co-gel and the step of forming said co-gel comprises combining an alkali metal silicate, a mineral acid, and a source of a second metal to form a hydrosol and allowing said hydrosol to set.

12. The method in accordance with claim 11, wherein the combining step comprises first mixing said mineral acid with said source of said second metal to form a mixture then combining said alkali metal silicate with said mixture.

13. The method in accordance with claim 11 or 12, wherein said second metal is selected from the group consisting of zirconium, titanium, aluminum, and iron.

14. The method in accordance with claim 13, wherein said second metal is zirconium and said source of zirconium is zirconium ortho-sulfate.

15. The product made by the process of any of claims 1 to 14.

16. The product in accordance with claim 15, wherein the product has an average pore diameter of at least 8 nm.

17. The product in accordance with claim 15 or 16, wherein the product has a surface area of 250 to 550 m²/g.

18. The product in accordance with claim 15 or 16, wherein the product has a surface area of at least 300 m²/g.

19. The product in accordance with claim 17, wherein the product has a surface area of 350 to 450 m²/g.

20. A method for making a catalyst comprising the steps of: combining an alkali metal silicate, a mineral acid, and a source of zirconium to form a hydrosol and allowing said hydrosol to set to form a co-gel; washing said co-gel; contacting said co-gel with an aqueous, acid bath comprising cesium to impregnate said co-gel with said cesium to form an activated component, wherein said bath has a pH below 7.0 at the end of the metal impregnation; and drying said activated component to form said catalyst.

21. The product made by the process of claim 20.

22. The product in accordance with claim 21 wherein the product has a surface area of at least 300 m²/g.

23. The product in accordance with claim 22, wherein the product has a surface area of 350 to 450 m²/g.
